(19) United States
(12) Patent Application Publication
(10) Pub. No.: US 2010/0287273 A1
(43) Pub. Date: Nov. 11, 2010

(54) SYSTEM AND METHOD FOR DIRECTING COMMUNICATIONS WITHIN A HETEROGENEOUS NETWORK ENVIRONMENT

(75) Inventors: Irfan Nasir, Lake In The Hills, IL (US); Lih-Tyng Hwang, Crystal Lake, IL (US); Magdi A. Mohamed, Schaumburg, IL (US); Aroon V. Tungare, Winfield, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/435,921

(22) Filed: May 5, 2009

(51) Int. Cl. G06F 15/173; H04B 7/26

(52) U.S. Cl. 709/224; 455/41.2

(57) ABSTRACT

Disclosed is a communications device that monitors the status of its communications links. When more than one communications link is available, an “appropriate” link is selected for use by an application running on the device. The links are continually monitored, and, as circumstances change, the link selection can also change. In some embodiments, a link is “appropriate” when it is available to transfer data and when it satisfies certain “hard” rules set by the application or by a user of the communications device. Some embodiments monitor the behaviour of the communications device and of its user and capture that behaviour in “soft” rules that are applied when selecting an appropriate link and when the hard rules leave the choice open. When multiple links transmit on the same frequency, they may be supported “virtually simultaneously” by time-slicing the actual data transmissions. Unneeded links may be shut down to save battery power.

### FIELD OF THE INVENTION

The present invention is related generally to network communications and, more particularly, to communicating efficiently in a heterogeneous network environment.

### BACKGROUND OF THE INVENTION

For many wireless devices, the network communications environment changes constantly, often minute-by-minute. Even for a stationary wireless device, signal strengths grow stronger and weaker, so new communications links become possible while other links become too weak and are dropped. When the device is mobile, this effect is even more strongly pronounced, of course. For a wireless device that supports multiple communications technologies, the availability of links supporting these various technologies can vary over time independently of one another.

When more than one communications link is available to a wireless device, the available links may vary in the capabilities they provide. For example, different links provide greater or lesser amounts of bandwidth or support different qualities of service. Also, different communications technologies may require differing amounts of battery power and may be associated with different billing structures.

Even when multiple communications links are simultaneously available to the wireless device, applications running on the device might be designed to work with only one, or with a small set, of possible communications technologies. (These limits may be imposed so that an application need only work with those links that can provide the quality of service needed by the application.) Thus an application may become “stranded” when its preferred link goes down even though other links are still available.

### BRIEF SUMMARY

The above considerations, and others, are addressed by the present invention, which can be understood by referring to the specification, drawings, and claims. According to aspects of the present invention, a communications device monitors the status of its communications links. When more than one communications link is available, an “appropriate” link is selected for use by an application running on the device. The links are continually monitored, and, as circumstances change, the link selection can also change. In some embodiments, the application need not be aware of the particular link it is using or when it is reconnected to a different link. In some embodiments, link-selection and status information is provided to the applications.

In some embodiments, a link is “appropriate” when it is available to transfer data and when it satisfies certain “hard” rules set by the application or by a user of the communications device. For example, hard rules can state a minimum bandwidth needed by an application, or a maximum acceptable latency, or a maximum cost-per-minute of connectivity. A hard rule may exclude as inappropriate a link using a certain technology if the level of battery charge in the device is below a certain level. Some embodiments monitor the behaviour of the communications device and of its user and capture that behaviour in “soft” rules that are applied when selecting an appropriate link and when the hard rules leave the choice open.

An application may be simultaneously connected to multiple links as circumstances permit. When multiple applications are running simultaneously on the device, they may share links or may use different links as circumstances and application requirements allow. When multiple links choose to transmit on the same frequency, they may be supported “virtually simultaneously” by time-slicing the actual data transmissions. If more links are available than are needed to support current requirements, extra links may be shut down to save battery power.

Different architectural implementations are contemplated. In some embodiments, the methods of the present invention are implemented, at least in part, by an “intelligent connectivity engine” that logically resides between the applications and the MAC (media-access control) layer logic running the various communications links.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational heterogeneous network environment in which the present invention may be practiced;

FIGS. 2a and 2b together form a flowchart of an exemplary method for directing communications within a heterogeneous network environment;

FIGS. 3a and 3b are schematics of an exemplary personal communications device usable with the present invention; and

FIG. 4 is a schematic of an exemplary intelligent connectivity engine implementing the present invention.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

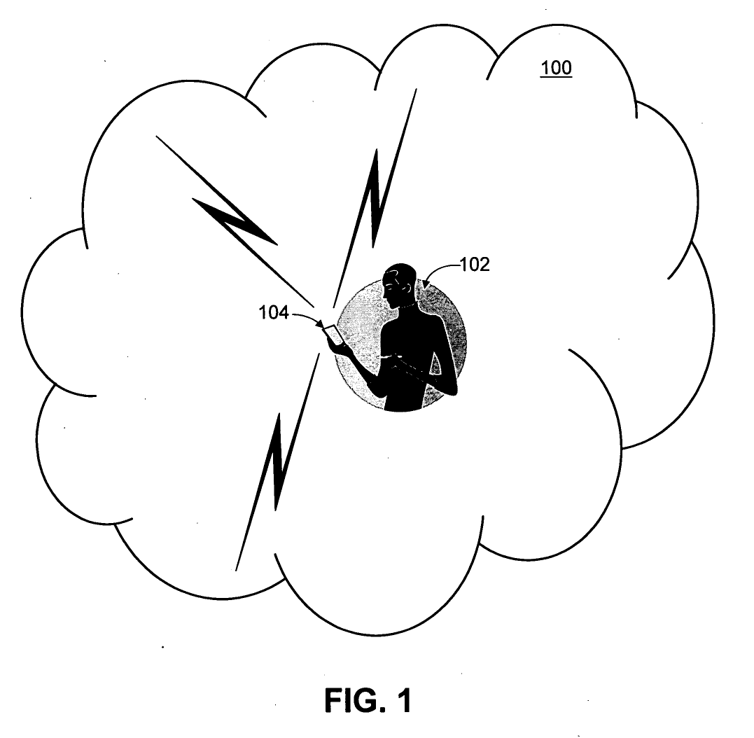

In FIG. 1, a person 102 is using his personal communications device 104 (e.g., a cellular telephone, digital assistant, or personal computer) in a heterogeneous networking environment 100. The networking environment 100 is called “heterogeneous” because the personal communications device 104 can potentially support multiple network links, where different network links may be based upon different technologies. For example, the personal communications device 104 may support cellular telephony and may be in contact with more than one cellular base station. In addition, the personal communications device 104 may support short-range radio links over Wi-Fi or Bluetooth. Another network link could be to a satellite-telephone provider. In some situations, the personal communications device 104 can simultaneously support multiple network links, while in other circumstances, the personal communications device 104 may need to choose among the available networks links and support only a subset of those links. The networking environment 100 is also heterogeneous because the set of available network links can change over time.

Note that the present invention is not limited to devices such as the personal communications device 104 as illustrated in FIG. 1. Rather, the principles of the present invention may be applied to any device that supports multiple network links.

Different network links can have different characteristics including strength of signal, bandwidth available, cost to use, and amount of power required from the personal communications device 104. While many network links support two-way communications, in this discussion a “network link” could also be a one-way service such as GPS broadcast signals received by the personal communications device 104.

Different network links also differ in how well they support user applications running on the personal communications device 104. For example, a voice-calling application requires only moderate bandwidth, but it does require low and reasonably consistent latency. A video application, on the other hand, may require much greater bandwidth but, with adequate buffering on the personal communications device 104, may be relatively insensitive to variations in latency. These and other network-link requirements of the applications are generally called “Quality of Service” (or “QoS”) requirements. Network links differ in the QoS requirements that they support. Also, as conditions in the heterogeneous networking environment 100 change, the ability of a given network link to support QoS requirements may change. Applications often codify their QoS requirements in a number of “hard” rules. If a network link cannot satisfy the hard rules of an application, then the application will not use that link. Of course, if no network link is available that satisfies the hard rules of the application, then that application must either quit or be suspended. The user 102 of the personal communications device 104 can also create hard rules that embody his preferences for the use of network links.

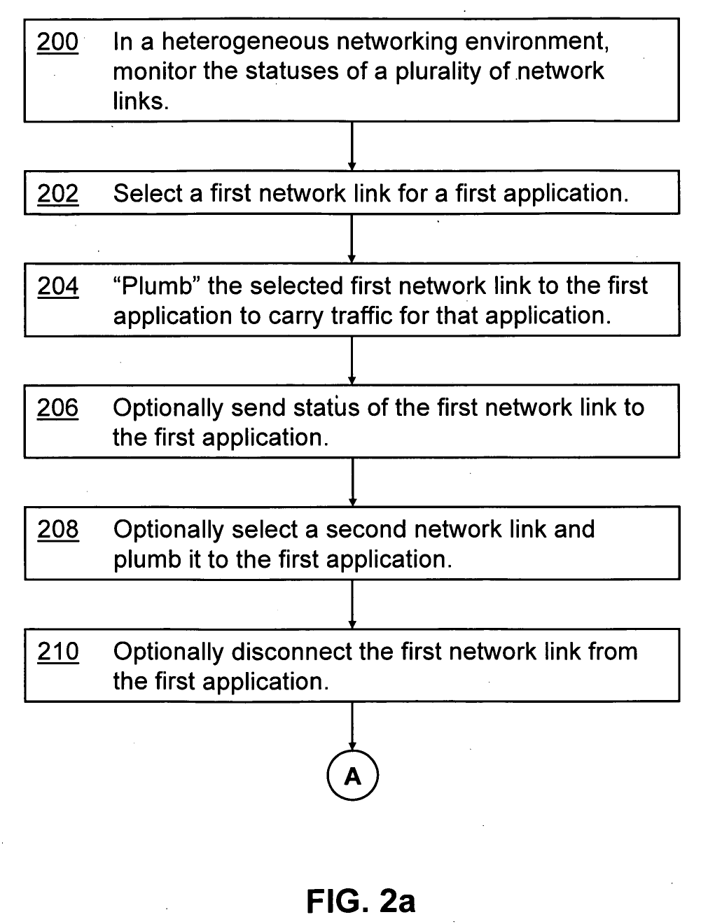

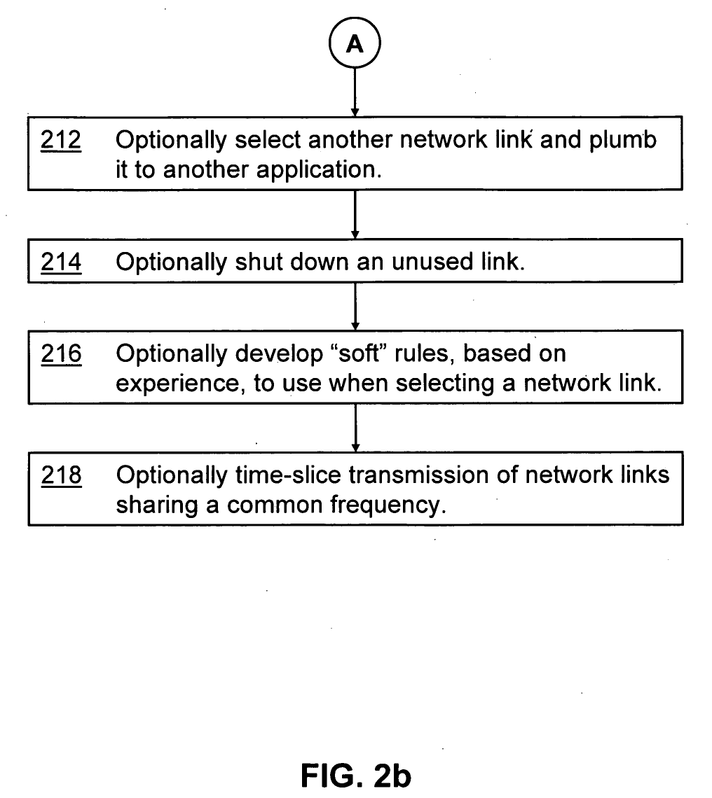

FIGS. 2a and 2b present a method, according to aspects of the present invention, for managing communications within a heterogeneous networking environment, such as environment 100 of FIG. 1. The method begins in step 200 where statuses of a plurality of network links are monitored. Different types of network links support different types of status information. Some links might only support a status of “available” or “unavailable.” Some links provide more information such as their ability to support various QoS requirements. Status information can also include data that changes only rarely such as cost to access the link and maximum theoretical bandwidth.

In step 202, a network link is selected for use with an application. In general, the requirements of the application are compared against the capabilities of the network links currently available to handle traffic, and a suitable link is chosen. The “hard” rules mentioned above in reference to FIG. 1 can be consulted so that, for example, a cheaper link is chosen (when available) for one type of application, while a link with a large guaranteed bandwidth is chosen for another application, even though it costs more. In some situations, more than one network link is available that meets the requirements of the application and the other hard rules. In some embodiments, past experience is consulted and codified into “soft” rules (see also step 216 of FIG. 2b). These soft rules can be used to select a network link among the set of suitable links.

The selected network link is “plumbed” into the application in step 204. Note that in some situations, the plumbing is “one-way,” as when the selected link carries GPS signals to a location-mapping application. The location-mapping application does not send any traffic back to the GPS satellites, so the link is strictly one-way. Other sensors work in this same way.

In some embodiments, steps 200 through 204 are kept out of sight of the application. That is, the application knows whether or not it connected to a working link that satisfies its QoS requirements (if any), but the application does not need to know anything more about the link it is using. In other embodiments, the application is given the status of the link it is using in step 206. It is also possible to give the status of other links so that the application can decide on its own to select another link.

In some embodiments, traffic for an application may be supported simultaneously on multiple links, possibly without the knowledge of the application itself. Step 208 allows for this possibility by plumbing a second link to the application. The second link can be chosen using the same criteria as in step 202.

In a more common circumstance, steps 208 and 210 are used together to hand off the application's traffic from one link to another. The handoff can be motivated by, say, a reduction in signal strength of the first link, which may indicate that the first link will shortly become unavailable. In another situation, a better information provider may become available. For example, the user 102 when driving may run a location application where his personal communications device 104 receives location information over Bluetooth from a GPS receiver in the car. When the user 102 enters a shopping mall, the device 104 may begin to receive location information from a Wi-Fi or ZigBee network. In general, a second link can be selected (step 202) and plumbed in (step 204) before the first link is dropped in step 210. Especially when the device 104 is mobile, it is expected that steps 200 through 210 will be applied repeatedly to support traffic for the application as the situation, specifically the availability of links, constantly changes. As discussed for step 206, these changes in the links used to support an application may occur with or without informing the application.

Step 212 of FIG. 2b simply notes that the methods of the present invention are available to simultaneously support multiple applications. It is possible that one link may be used to support multiple applications, again possibly without the knowledge of those applications. Of course, the availability of links that satisfy the QoS requirements of the applications may restrict the number of applications supported at a given time.

It usually takes some resources, specifically some battery power, to support a link even when the link is not being used. In step 214, an unused link can be shut down to save power. This step may interact with the above steps when the amount of remaining power becomes a matter of concern. When it is necessary to conserve power, links may be selected (step 202) based on their power requirements, even when otherwise more desirable links (e.g., links of higher bandwidth or lower latency) are available. Traffic for the applications can be handed off to these lower-power links (steps 208 and 210), and the higher-power links can be shut down (step 214). This process may be reversed when more power becomes available or when the amount of power drain decreases (e.g., when some applications are shut down).

In the discussion of step 202 of FIG. 2a, “soft” rules are described as codified experience. In step 216, these soft rules are developed by monitoring responses to various situations. When similar situations occur again, the soft rules provide guidance for a response. Generally, soft rules cannot override the hard rules set by the user or by the applications.

Step 208 discusses sharing traffic for one application over multiple links. Step 212 discusses sharing traffic for multiple applications over a common link. Step 218 shows another possible type of sharing. Multiple links may use the same radio frequency. To simultaneously support these links, the resource of their common frequency is shared by time-slicing their transmissions. Each link remains available, although the total bandwidth available to each link is reduced by the bandwidth requirements of the other links sharing this frequency.

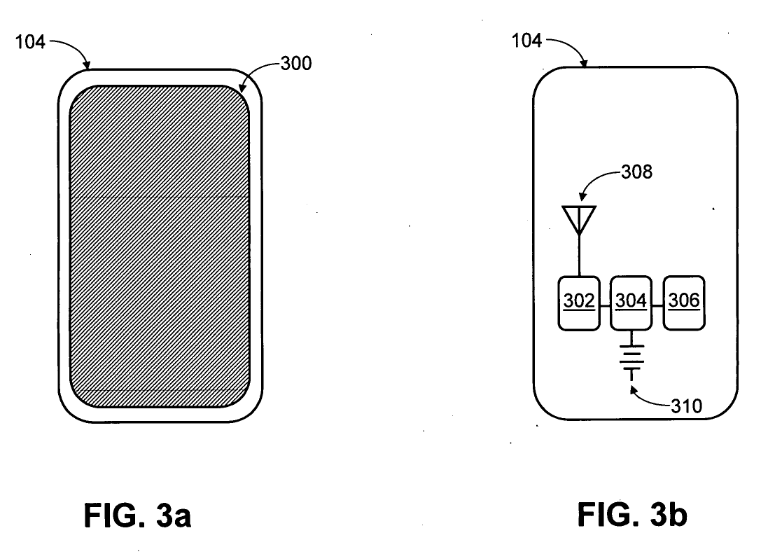

FIGS. 3a and 3b show a personal communications device 104 (e.g., a cellular telephone, personal digital assistant, or personal computer) that incorporates an embodiment of the present invention. Note that the present invention is not restricted to mobile devices but can be implemented in any device that connects to a network. FIGS. 3a and 3b show the device 104 as a cellular telephone presenting a touch-screen interface 300 to the user 102. The user 102 can use the interface 300 to run applications and to specify hard rules about network-link usage.

FIG. 3b illustrates some of the more important internal components of the personal communications device 104. The device 104 includes at least one communications transceiver 302, a processor 304, a memory 306 for storing, among other things, applications and rules, an antenna 308, and a battery 310.

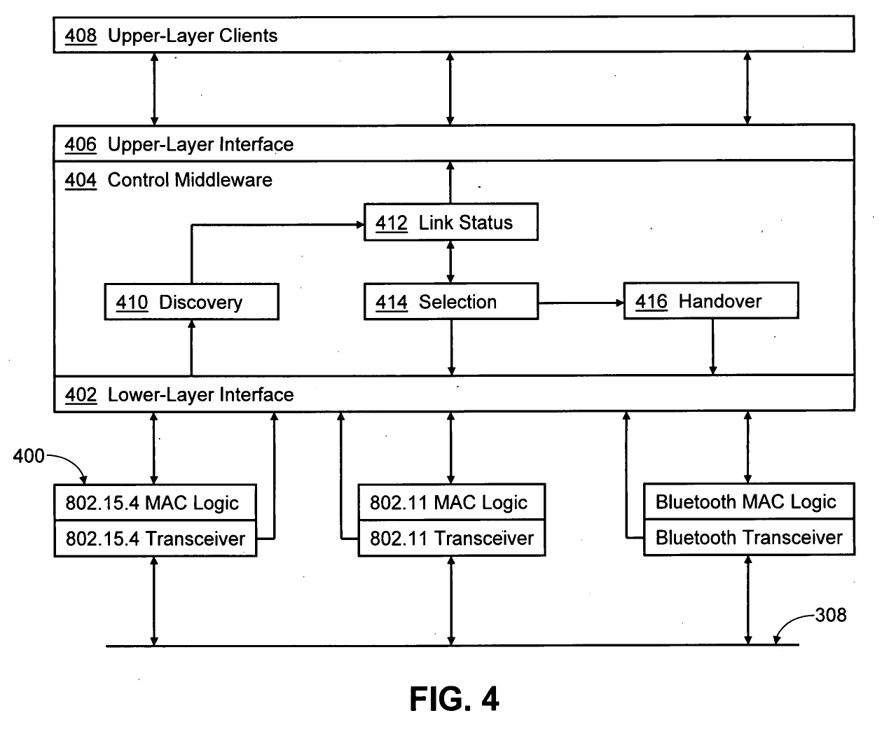

FIG. 4 presents an exemplary embodiment of an intelligent connectivity engine, running on the personal communications device 104, that embodies some aspects of the present invention. Starting at the bottom of FIG. 4, one or more antennae 308 provide physical connectivity to network links in a heterogeneous networking environment. Note that the present invention is also designed to work with network links that do not use an antenna, for example, fiber-optic or hard-wired links.

Connected to the one or more antennae 308 are network communications engines 400. The example of FIG. 4 uses the terminology of the well known ISO OSI protocol communications stack. The lowest level in that stack is denoted the physical layer. The transceivers in the network communications engines 400 handle physical-layer communications. The network communications engines 400 also handle the next layer up with their media-access control logic. FIG. 4 shows three representative network communications engines 400: one for IEEE 802.15.4, one for IEEE 802.11, and one for Bluetooth. Aspects of the present invention can be used with protocols other than those shown in FIG. 4, such as Wi-Fi and ZigBee, and even with protocols that do not map well to the ISO OSI stack.

Sitting logically above the network communications engines 400 is the intelligent connectivity engine, shown in three parts: a lower-layer interface 402 that communicates with the network communications engines 400, a control middleware 404, and an upper-layer interface 406 that communicates with applications and other upper-layer clients 408. In the embodiment of FIG. 4, the method of FIGS. 2a and 2b runs on the control middleware 404.

Some of the functions of the control middleware 404 are shown in FIG. 4. The discovery logic 410 monitors the network communications engines 400 to discover and record the statuses 412 of the network links (step 200 of FIG. 2a). Based on the link statuses 412, on the QoS requirements of the upper-layer clients 408, and on any other applicable hard and soft rules, appropriate network links are selected (step 202) and then plumbed into the upper-layer clients 408 (step 204). When necessary, traffic for an upper-layer client 408 is handed over 416 to another network link (steps 208 and 210).

By its logical position between the upper-layer clients 408 and the network communications engines 400, the intelligent connectivity engine 402, 404, 406 is able to abstract connectivity details from the upper-layer clients 408. The upper-layer clients 408 are provided with the best connectivity available without having to worry about such considerations as which links are available, how much they cost in money and power, etc. The control middleware 404 can combine traffic from multiple upper-layer clients 408 onto one network link, split traffic from one network link to multiple upper-layer clients 408, and move traffic from one network link to another, all without the notice of the upper-layer clients 408. As noted above, however, in some embodiments, the upper-layer clients 408 can be kept informed of these changes (step 206 of FIG. 2a).

The position of the intelligent connectivity engine 402, 404, 406 also allows it, in some embodiments, to route traffic coming in from one network link out to another network link without the mediation of an upper-layer client 408.

In view of the many possible embodiments to which the principles of the present invention may be applied, it should be recognized that the embodiments described herein with respect to the drawing figures are meant to be illustrative only and should not be taken as limiting the scope of the invention. For example, different communications protocols may call for differences in the architecture of the intelligent connectivity engine. Therefore, the invention as described herein contemplates all such embodiments as may come within the scope of the following claims and equivalents thereof.

We claim:

1. A method for communicating in a heterogeneous network environment, the method comprising:
monitoring statuses of a plurality of network links, the statuses provided by a plurality of network communications engines;
based, at least in part, on the network-link statuses provided by the network communications engines, selecting a first network link for a first application; and
directing at least some communications from the first network link to the first application.

2. The method of claim 1 wherein the plurality of network links support protocols selected from the group consisting of: Wi-Fi, Bluetooth, and ZigBee.

3. The method of claim 1 wherein selecting a network link is based, at least in part, on a consideration selected from the group consisting of: power required by a network link, battery charge level of a device running the method, Quality-of-Service provided by a network link, latency experienced on a network link, bandwidth provided by a network link, hard rules provided by a user, soft rules discovered based on experience, and requirements of the first application.

4. The method of claim 1 further comprising:
directing at least some communications from the first application to the first network link.

5. The method of claim 1 further comprising:
directing at least some communications from the first application to a second network link, the second network link distinct from the first network link.

6. The method of claim 1 further comprising:
based, at least in part, on the network-link statuses provided by the network communications engines, selecting a second network link for the first application, the second network link distinct from the first network link;
ceasing to direct communications from the first network link to the first application; and
directing at least some communications from the second network link to the first application.

7. The method of claim 1 further comprising:
directing at least some information from a sensor to the first application.

8. The method of claim 1 further comprising:
based, at least in part, on the network-link statuses provided by the network communications engines, selecting a second network link for a second application, the second network link distinct from the first network link, the second application distinct from the first application; and
directing at least some communications from the second network link to the second application.

9. The method of claim 1 further comprising:
saving power by directing a network communications engine to shut down a network link.

10. The method of claim 1 further comprising:
developing soft rules based on experience.

11. The method of claim 1 further comprising:
coordinating transmissions on two network links sharing a common frequency by time-slicing the transmissions.

12. The method of claim 1 further comprising:
sending a network-link status to the first application.

13. A personal communications device configured for communicating in a heterogeneous network environment, the personal communications device comprising:
one or more transmitters;
a plurality of network communications engines operatively coupled to the one or more transmitters; and
a processor operatively coupled to the network communications engines, the processor configured for:
monitoring statuses of a plurality of network links, the statuses provided by the network communications engines;
based, at least in part, on the network-link statuses provided by the network communications engines, selecting a first network link for a first application; and
directing at least some communications from the first network link to the first application.

14. The personal communications device of claim 13 wherein the processor is further configured for:
directing at least some communications from the first application to the first network link.

15. The personal communications device of claim 13 wherein the processor is further configured for:
directing at least some communications from the first application to a second network link, the second network link distinct from the first network link.

16. The personal communications device of claim 13 wherein the processor is further configured for:
based, at least in part, on the network-link statuses provided by the network communications engines, selecting a second network link for the first application, the second network link distinct from the first network link;
ceasing to direct communications from the first network link to the first application; and
directing at least some communications from the second network link to the first application.

17. The personal communications device of claim 13 further comprising:
a sensor operatively coupled to the processor;
wherein the processor is further configured for directing at least some information from the sensor to the first application.

18. The personal communications device of claim 13 wherein the processor is further configured for:
based, at least in part, on the network-link statuses provided by the network communications engines, selecting a second network link for a second application, the second network link distinct from the first network link, the second application distinct from the first application; and
directing at least some communications from the second network link to the second application.

19. The personal communications device of claim 13 wherein the processor is further configured for:
saving power by directing a network communications engine to shut down a network link.

20. The personal communications device of claim 13 wherein the processor is further configured for:
developing soft rules based on experience.

21. The personal communications device of claim 13 wherein the processor is further configured for:
coordinating transmissions on two network links sharing a common frequency by time-slicing the transmissions.
